(19) United States
(12) Patent Application Publication
(10) Pub. No.: US 2006/0266799 A1
(43) Pub. Date: Nov. 30, 2006

(54) Slag detachability

(75) Inventors: Daya Singh, Bainbridge Township, OH (US); Badri K. Narayanan, Euclid, OH (US); Patrick T. Soltis, Shaker Hts., OH (US)

Correspondence Address: Robert V. Vickers, Esq.;Fay, Sharpe, Fagan, Minnich & McKee, LLP, Seventh Floor, 1100 Superior Avenue, Cleveland, OH, 44114-2518, US

(73) Assignee: Lincoln Global, Inc.

(21) Appl. No.: 11/141,484

(22) Filed: May 31, 2005

(51) Int. Cl. A47J 36/02

(52) U.S. Cl. 228/101

(57) ABSTRACT

An electrode composition is disclosed, particularly useful for arc welding and utilized in a flux-cored arc electrode, which produces a slag that is readily removable. The electrode composition employs aluminum and magnesium in a atomic ratio of 1.5:1 or more, respectively. Also disclosed are methods for facilitating the removal of slag by use of particular electrode or welding compositions.

The present invention relates to the art of arc welding and more particularly, improving the ease with which slag can be removed from arc welds.

### BACKGROUND OF INVENTION

Most common metal joining methods using an electric arc are gas-metal arc welding with solid (GMAW) or metal-cored wires (GMAW-C), gas shielded flux-cored arc welding (FCAW-G), self-shielded flux-cored arc welding (FCAW-S), shielded metal arc welding (SMAW) and submerged arc welding (SAW).

Flux-cored electrodes are used increasingly as an alternative to solid wires because of increased productivity during welding fabrication of structural components. Flux-cored electrodes are composite electrodes consisting of a core (fill) material surrounded by a metallic outer sheath. The core consists mainly of iron powder and alloying and fluxing ingredients to help with arc stability, weld wetting and appearance etc., such that the desired appearance and mechanical properties are obtained in the weld. Flux-cored electrodes provide increased deposition rates and produce a wider, more consistent weld penetration profile compared to solid electrodes. Moreover, they provide improved arc action, generate less fume and spatter, and provide weld deposits with better wetting compared to solid electrodes and allow out of position welding. However, these productivity improvements are sometimes offset by the expense incurred because of the time required to remove slag deposits or islands, which form on the surface of the weld.

One of the main functions of fluxing agents in welding is to produce a slag which will cover and protect the surface of the weld pool from the atmosphere. Slag is formed by melting the fluxing agents, it is a deoxidation product from the reaction between the flux, atmosphere, molten sheath and alloy components in the core. Slag can become trapped in the weld when two adjacent weld beads are deposited with inadequate overlap and poor bead shape and a void is formed. When the next layer is deposited, the entrapped slag is not melted out. Slag may also become entrapped in cavities in multi-pass welds through excessive undercut in the weld toe or the uneven surface profile of the preceding weld runs.

The ability to remove slag with relative ease is an important factor in welding processes using flux. Time and effort required to remove slag lowers productivity. Incomplete removal of slag can lead to weld defects like slag inclusions, lower the corrosion resistance of the weld and impair the appearance of the weldment and can compromise weldment integrity.

The composition of the flux plays an important role in the risk of slag inclusions through its effect on the weld bead shape and the ease with which the slag can be removed. Melting point of the slag has an effect on the amount of inclusions in the weld metal and the ability to weld out of position. A weld pool with low oxygen content will have a high surface tension producing a convex weld bead with poor parent metal wetting. Thus, an oxidizing flux, containing for example iron oxide, produces a low surface tension weld pool with a more concave weld bead profile, and promotes wetting into the parent metal. High silicate flux produces a glass-like slag, often self-detaching. Fluxes with a lime content produce an adherent slag which is difficult to remove.

The ease of slag removal varies depending upon the type of flux used. For rutile or acid fluxes, i.e. large amounts of titanium oxide (rutile) with some silicates, the oxygen level of the weld pool is high enough to produce a flat or slightly convex weld bead. The fluidity of the slag is determined by the calcium fluoride content. Fluoride-free coatings designed for welding in the flat position produce smooth bead profiles and an easily removed slag. The more fluid fluoride slag designed for positional welding is less easily removed. For basic fluxes, the high proportion of calcium carbonate (limestone) and calcium fluoride (fluorspar) in the flux reduces the oxygen content of the weld pool and therefore its surface tension. The slag is more fluid than that produced with the rutile coating. Fast freezing also assists welding in the vertical and overhead positions but the slag coating is more difficult to remove. Consequently, the risk of slag inclusions is significantly greater with basic fluxes due to the inherent convex weld bead profile and the difficulty in removing the slag from the weld toes especially in multi-pass welds.

Efforts toward slag removal have concentrated on tailoring the composition of the flux and/or core (fill) of a metal-core electrode. Several fill compositions have been developed to address the slag removal problem. In U.S. Pat. No. 4,345,140 to Godai, a flux composition used in a cored electrode for welding stainless steel is disclosed. Godai discloses that the addition of low melting point metallic oxides such as lead oxide, copper oxide, bismuth oxide, antimony oxide or tin oxide is useful for enhancing the separability of slag from the underlying weld.

Another fill composition having improved slag removal is disclosed in U.S. Pat. No. 6,608,284 to Nikodym. Nikodym discloses a fill composition for a mild steel or low alloy steel electrode. Nikodym distinguishes the disclosed fill composition from the fill composition disclosed in Godai on the basis that Godai is directed to a flux-cored electrode for stainless steel welding which is fundamentally different from metal-cored electrodes for mild steel and low alloy steel welding. Nikodym asserts that flux-cored electrodes for use in the welding of stainless steel include a flux composition consisting of nonmetallic inorganic components that are present in significantly higher percentages (e.g., 5 to 10%) than in metal-cored electrodes for use in the welding of mild or low alloy metals, thus resulting in the slag covering the entire surface and adhering strongly to the weld bead thereby making it very difficult to remove. The fill composition disclosed in Nikodym includes the addition of antimony, bismuth and/or germanium to a weld metal to cause slag deposits or islands on the weld metal to form at positions away from the toe or edge of mild and low alloy steel weld beads, thereby facilitating the removal of the slag deposits or islands.

For the FCAW-S electrodes Al and Mg are used for removing oxygen and nitrogen from the molten weld metal and form a major part of slag as their respective oxides. Although efforts have been directed to reducing the extent and occurrence of slag deposits, such as by the addition of various elements to the flux or core (fill) material, a need remains for another strategy for facilitating slag removal.

### THE INVENTION

In a first aspect, the present invention provides a method for facilitating removal of slag otherwise having a weight ratio of aluminum oxide to magnesium oxide of about 1:1, respectively, or less with regard to the amount of aluminum oxide, resulting from arc welding a cored electrode. The method comprises adjusting the flux composition in the electrode such that the weight ratio of aluminum oxide to magnesium oxide in the slag is about 2:1, respectively, or more with regard to the amount of aluminum oxide.

In another aspect, the present invention provides a method for facilitating removal of slag otherwise having a weight ratio of aluminum oxide to magnesium oxide of about 1:1, respectively, or less with regard to the amount of aluminum oxide, resulting from arc welding a cored electrode. The method comprises adjusting the welding electrode composition such that the atomic ratio of total aluminum to total magnesium in the welding electrode is about 3:2, respectively, or more with regard to the amount of aluminum.

In yet another aspect according to the present invention, a method for facilitating the removal of slag resulting from arc welding a cored electrode is provided. The method comprises using a cored electrode having a atomic ratio of total aluminum to total magnesium in the cored electrode of from about 3:2, respectively, or more with regard to the amount of aluminum.

In yet a further aspect according to the present invention, a cored metal electrode adapted for self-shielded flux cored arc welding processes is provided. The electrode comprises a atomic ratio of total aluminum to total magnesium of at least about 3:2, respectively, with an upper limit of aluminum in the electrode corresponding to about 1.1% by weight aluminum in the resulting weld metal.

### BRIEF DESCRIPTION OF DRAWINGS

FIG. 1 is a schematic cross-sectional view of a weld layer, a slag layer, and the interface therebetween.

### PREFERRED EMBODIMENTS

Slag formation is an integral part of self-shielded FCAW-S (self-shielded flux-cored arc welding) processes. Aluminum and magnesium are the primary deoxidizing and denitriding agents used in the electrode to deposit a porosity-free weld metal. Almost all of the magnesium and most of the aluminum present in the electrode end up in the slag as oxides. However, limits exist as to the maximum amount of aluminum that can be incorporated in the electrode.

Aluminum in the weld deposit has a detrimental effect on toughness of the weld metal, and that factor often limits the amount of aluminum in the electrode. Therefore, a certain amount of magnesium is used in conjunction with aluminum. When equal weight amounts of aluminum oxide (Al₂O₃) and magnesium oxide (MgO) are present in the slag, the slag detachability is poor.

In accordance with the present discovery, as the weight amount of aluminum oxide is increased to about two or more times that of magnesium oxide in the slag, the detachability of the slag significantly improves. This weight ratio of aluminum oxide to magnesium oxide in the slag can also be represented as a atomic ratio of elemental aluminum to elemental magnesium in the electrode. If the ratio of elemental aluminum to magnesium is maintained at about 3:2 or more (with regard to the amount of aluminum) in the electrode, the slag detachability is significantly improved. These ratios can also be altered by adding or reducing different amounts of oxide in the electrode. For example, a 1:1 atomic ratio of Al:Mg in an electrode can be altered with a 5% addition of aluminum oxide to the electrode or with a reduction of 5% of magnesium oxide from the electrode. Thermodynamic modeling of the phase structure of the slag suggests that this improvement results from the change in amounts of MgO and spinel-type phases (MgO—Al₂O₃) in the resulting slag.

Spinels make up a complex oxide class with a close-packed oxygen ion matrix and divalent and trivalent metallic cations which are positioned in interstitial sites. Spinel compounds are a very common oxide phase found in the slags formed during arc welding of carbon and alloy steels. These structures often include various oxides of aluminum and magnesium. Spinels exhibit a crystal lattice structure that readily bonds to an iron substrate.

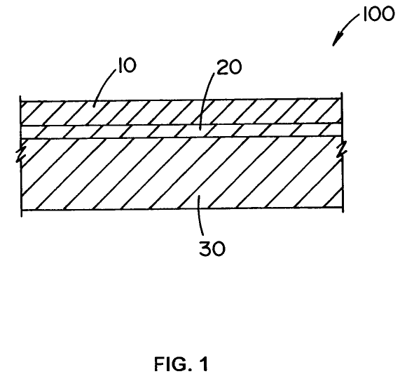

Referring to FIG. 1, a schematic cross section 100 is illustrated depicting a layer of slag 10 disposed on weld metal 30. An interface 20 is defined between the slag 10 and the weld metal 30. It will be appreciated by those skilled in the art that FIG. 1 is not to scale, and the thicknesses of the layers are not necessarily as depicted. In fact, the thickness of the interface 20 will likely be significantly thinner, than shown. Generally, the ease or difficulty in removing the slag 10 from weld metal 30 depends upon the extent of bonding between those regions within or along the interface 20. Although not wishing to be bound to any particular theory, it is believed that the slag layer 10 can be very difficult to remove from the weld metal 30 due to the close similarity between the metal lattice structure of weld metal 30, and the crystal lattice structure within the interface 20 which, for welding electrodes including aluminum and magnesium, contain spinels. As noted, it is believed that spinels exhibit a crystal lattice structure that readily bonds to iron substrates.

In accordance with the present invention, by adjusting the atomic ratio of aluminum to magnesium in the electrode or the welding composition to 3:2 or more, the resulting crystal lattice structure within the interface 20 is disrupted, thereby decreasing the extent of bonding between the slag layer 10 and the weld metal 30. Alternately, the invention can also be performed by using a welding composition or an electrode that contains a atomic ratio of aluminum to magnesium of 3:2 or more, respectively (with regard to the aluminum content). Moreover, the invention can be performed by using a welding composition, an electrode, and/or welding conditions such that the weight ratio of aluminum oxide to magnesium oxide in the slag is about 2:1, respectively, or more (with regard to the amount of aluminum oxide). Specifically, particular welding compositions can be used to achieve desired ratios of aluminum oxide to magnesium oxide in the slag. The term “welding composition” as used herein generally refers to the composition of the electrode, but can also refer to the collective composition if more than one electrode is used, or an electrode and one or more ancillary feeds of alloying elements are utilized.

The slag composition can be altered by modifying the ratio of aluminum-bearing and magnesium-bearing agents in the electrode or the welding composition. Specifically, this can be performed by the addition of aluminum, aluminum oxide, ferro-aluminum, or intermetallics of aluminum in the electrode or the welding composition. This can also be performed by reducing the amounts of the magnesium or magnesium-bearing agents such as magnesium oxide in the electrode or the welding composition.

More specifically, in accordance with a preferred aspect of the present invention, a method is provided for improving slag detachability characteristics of a flux cored electrode having an electrode composition in which the atomic ratio of Al:Mg in the electrode is less than about 1.5:1 (with regard to the aluminum content) to about 1:1, respectively. The method involves either (i) increasing the amount of aluminum or (ii) decreasing the amount of magnesium in the electrode such that the atomic ratio of Al:Mg in the electrode is greater than about 1.5:1, such as about 1.6:1, about 1.7:1, about 1.8:1, about 1.9:1, about 2:1, and more than 2:1 for example. The upper limit of the amount of aluminum depends upon the particular application and requirements of the resulting weld. Certain applications may dictate that the amount of aluminum in the final weld should not exceed about 1.4% by weight.

In accordance with another preferred aspect of the present invention, a flux cored electrode is provided which exhibits excellent slag detachability properties when used in a welding process. The atomic ratio of the total amount of aluminum to the total amount of magnesium in the electrode is about 1.5:1 or greater than 1.5:1, respectively. As noted, a cored electrode is a continuously fed tubular metal sheath with a core of powdered flux and/or alloying ingredients. These may include fluxing elements, deoxidizing and denitriding agents, and alloying materials, as well as elements that increase toughness and strength, improve corrosion resistance, and stabilize the arc. Typical core materials may include aluminum, calcium, carbon, chromium, iron, manganese, and other elements and materials. While flux-cored electrodes are more widely used, metal-cored products are useful for adjusting the filler metal composition when welding alloy steels. The powders in metal-cored electrodes generally are metal and alloy powders, rather than compounds, producing only small islands of slag on the face of the weld. By contrast, flux-cored electrodes produce an extensive slag cover during welding, which supports and shapes the bead.

Various empirical or qualitative approaches exist for designating the ease (or difficulty) with which slag can be removed from a weld. One such approach is the use of a five unit system in which 5 stands for the worst or most difficult to remove, while 1 designates the easiest to remove. An example of such a system is as follows:

TABLE 1
SLAG REMOVAL RATING SYSTEM

| SLAG | |
|---|---|
| REMOVAL | |
| DIFFICULTY | DESCRIPTION |
| 1 | Slag easily removed, can be peeled off. |
| 2 | Slag easily removed by brushing, light scraping or |
| | raking. |
| 3 | Slag moderately removable by scraping or light |
| | chipping. |
| 4 | Slag difficult to remove, requires extensive chipping |
| | or light grinding. |
| 5 | Slag exceedingly difficult to remove, removable only |
| | by extensive grinding. |

The preferred embodiment welding electrodes featuring the noted ratios of Al:Mg as described herein, produce slags that fall into the 1 to 2 region of the rating system set forth in Table 1. Corresponding electrodes including Al and Mg, however in ratios of about 1:1, or otherwise outside the preferred ranges described herein, produce slags that fall in the 4 to 5 region of the rating system. This improvement in slag removal constitutes a significant advance in the art and is expected to be commercially important.

Additional details of arc welding materials and specifically, cored electrodes for welding are provided in U.S. Pat. Nos. 5,369,244; 5,365,036; 5,233,160; 5,225,661; 5,132,514; 5,120,931; 5,091,628; 5,055,655; 5,015,823; 5,003,155; 4,833,296; 4,723,061; 4,717,536; 4,551,610; and 4,186,293; all of which are hereby incorporated by reference.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

Having thus defined the invention, the following is claimed:

1. A method for facilitating removal of slag otherwise having a weight ratio of aluminum oxide to magnesium oxide of about 1:1, respectively, or less with regard to the amount of aluminum oxide, resulting from arc welding a cored electrode, the method comprising:
adjusting the welding composition such that the weight ratio of aluminum oxide to magnesium oxide in the slag is about 2:1, respectively, or more with regard to the amount of aluminum oxide.

2. The method of claim 1 wherein the atomic ratio of total aluminum to total magnesium in the welding composition after adjusting is about 3:2, respectively, or more with regard to the amount of aluminum.

3. The method of claim 2 whereby the atomic ratio is adjusted to about 1.6:1.

4. The method of claim 2 whereby the atomic ratio is adjusted to about 1.7:1.

5. The method of claim 2 whereby the atomic ratio is adjusted to about 1.8:1.

6. The method of claim 2 whereby the atomic ratio is adjusted to about 1.9:1.

7. The method of claim 2 whereby the atomic ratio is adjusted to about 2:1.

8. The method of claim 2 whereby the atomic ratio is adjusted to be from about 3:2 to an upper limit corresponding to about 1.4% by weight of aluminum in the weld metal.

9. The method of claim 8 whereby the atomic ratio is adjusted to be more than 2:1.

10. The method of claim 1 wherein the adjusting is performed by adding an agent to the welding composition selected from the group consisting of aluminum, aluminum oxide, ferro-aluminum, intermetallics of aluminum, and combinations thereof.

11. The method of claim 1 wherein the adjusting is performed by reducing the amount of magnesium in the welding composition.

12. A method for facilitating removal of slag otherwise having a weight ratio of aluminum oxide to magnesium oxide of about 1:1, respectively, or less with regard to the amount of aluminum oxide, resulting from arc welding a cored electrode, the method comprising:
adjusting the welding composition such that the atomic ratio of total aluminum to total magnesium in the welding composition is about 3:2, respectively, or more with regard to the amount of aluminum.

13. The method of claim 12 whereby the atomic ratio is adjusted to about 1.6:1.

14. The method of claim 12 whereby the atomic ratio is adjusted to about 1.7:1.

15. The method of claim 12 whereby the atomic ratio is adjusted to about 1.8:1.

16. The method of claim 12 whereby the atomic ratio is adjusted to about 1.9:1.

17. The method of claim 12 whereby the atomic ratio is adjusted to about 2:1.

18. The method of claim 12 whereby the atomic ratio is adjusted to be from about 3:2 to an upper limit corresponding to about 1.4% by weight of aluminum in the weld metal.

19. The method of claim 18 whereby the atomic ratio is adjusted to be more than 2:1.

20. The method of claim 12 wherein the adjusting is performed by adding an agent to the welding composition selected from the group consisting of aluminum, aluminum oxide, ferro-aluminum, intermetallics of aluminum, and combinations thereof.

21. The method of claim 12 wherein the adjusting is performed by reducing the amount of magnesium in the welding composition.

22. A method for facilitating the removal of slag resulting from arc welding a cored electrode, the method comprising:
using a cored electrode having a atomic ratio of total aluminum to total magnesium in the cored electrode of from about 3:2, respectively, or more with regard to the amount of aluminum.

23. The method of claim 22 whereby the atomic ratio is about 1.6:1.

24. The method of claim 22 whereby the atomic ratio is about 1.7:1.

25. The method of claim 22 whereby the atomic ratio is about 1.8:1.

26. The method of claim 22 whereby the atomic ratio is about 1.9:1.

27. The method of claim 22 whereby the atomic ratio is about 2:1.

28. The method of claim 22 whereby the atomic ratio is from about 3:2 to an upper limit corresponding to about 1.4% by weight of aluminum in the weld metal.

29. The method of claim 22 whereby the atomic ratio is more than 2:1.

30. A cored metal electrode adapted for self-shielded flux-cored arc welding processes, the electrode comprising:
a atomic ratio of total aluminum to total magnesium of at least about 3:2, respectively, with an upper limit of aluminum in the electrode corresponding to about 1.4% by weight aluminum in the resulting weld metal.

31. The electrode of claim 30 wherein the atomic ratio is about 1.6:1.

32. The electrode of claim 30 wherein the atomic ratio is about 1.7:1.

33. The electrode of claim 30 wherein the atomic ratio is about 1.8:1.

34. The electrode is of claim 30 wherein the atomic ratio is about 1.9:1.

35. The electrode of claim 30 wherein the atomic ratio is about 2:1.

36. The electrode of claim 30 wherein the atomic ratio is more than 2:1.
